(19) United States
(12) Patent Application Publication
(10) Pub. No.: US 2025/0021814 A1
(43) Pub. Date: Jan. 16, 2025

(54) Variable Matrices for Machine Learning

(71) Applicant: PayPal, Inc., San Jose, CA (US)

(72) Inventors: Ying Lin, Shanghai (CN); Shiwen Song, Shanghai (CN); Yingying Yu, Shanghai (CN)

(21) Appl. No.: 18/455,134

(22) Filed: Aug. 24, 2023

(30) Foreign Application Priority Data
Jul. 13, 2023 (WO) PCT/CN2023/107148

(51) Int. Cl. G06N 3/08; G06F 17/16; G06N 3/045

(52) U.S. Cl. CPC G06N 3/08; G06F 17/16; G06N 3/045

(57) ABSTRACT

Techniques are disclosed for generating multi-dimensional variable matrices for predicting abnormality of electronic communications. After receiving the request for a new communication from a given entity, a system retrieves attributes of the entity. The system generates, a variable matrix for the entity with a variable dimension corresponding to a number of variables determined for the entity based on the entity's attributes and an entity dimension corresponding to a number of other entities with which the entity performed communications. The system inputs the variable matrix into a trained machine learning model and determines, based on an abnormality score output by the model, whether the communication requested by the entity corresponds to anomalous behavior. The disclosed techniques may advantageously provide a greater distribution of data for an entity using a multi-dimensional variable matrix for anomaly prediction e.g., using machine learning relative to traditional techniques that compress the distribution to a one-dimensional statistic.

### PRIORITY CLAIM

The present application claims priority to PCT Appl. No. PCT/CN2023/107148, entitled “VARIABLE MATRICES FOR MACHINE LEARNING”, filed Jul. 13, 2023, which is incorporated by reference herein in its entirety.

### BACKGROUND

### Technical Field

This disclosure relates generally to data processing, and, more specifically, to techniques for detecting anomalies in source data, for example, using machine learning.

### Description of the Related Art

As more and more systems have access to larger and larger amounts of data (often referred to as “big data”), the ability to process this data become paramount, particularly for systems that need to understand or identify certain patterns in the data. For example, many systems may wish to identify abnormal distributions in the data. Often, an abnormal distribution in a given set of data is calculated using statistical methods which compress the distribution of data into a one-dimensional statistic. Such compression methods often cause a significant amount of information about the data to be lost. For example, a single characteristic or variable of the data may be analyzed to determine what a characteristic or variable is for a given entity (e.g., the total payment volume of a user at a given point in time) to which the characteristic or variable corresponds. Such analysis is often not representative of the overall abnormal distribution of data for the given entity since a given variable may change greatly over time and there are a plethora of different types of characteristics or variables which correspond to the given entity and indicate its behavior.

Many electronic communication requests (one example of the data that may be processed), such as electronic transactions may be submitted with malicious intent, often resulting in wasted computer resources, network bandwidth, storage, CPU processing, etc. In this example, such computing resources may be wasted if the electronic communications are processed based on inaccurate predictions performed using compressive one-dimensional statistical methods. For example, if a variable for a given entity is analyzed as individual data points (at different points in time), then the behavior of this entity may not be accurately determined. That is, an isolated data point for a given entity indicating the total payment volume of that entity at a given time will not represent the entity's behavior as accurately as the analysis of multiple data points for the given entities captured at different points in time (i.e., the multiple data points more accurately indicate behavioral abnormalities of this entity than the individual data points). The isolated analysis of individual data points may result in a system inaccurately predicting that an entity requesting an electronic communication is not exhibiting abnormal behavior, causing the requested communication to be processed (even though it may indeed be suspicious) which often results in both computational and monetary loss.

### BRIEF DESCRIPTION OF THE DRAWINGS

FIG. 1 is a block diagram illustrating an example system configured to generate variable matrices for use in training a machine learning model, according to some embodiments.

FIGS. 2A and 2B are block diagrams illustrating example variable and normalization modules, according to some embodiments.

FIG. 3 is a block diagram illustrating example input module, according to some embodiments.

FIG. 4 is a diagram illustrating an example variable graph, according to some embodiments.

FIG. 5 is a block diagram illustrating an example variable matrix and an example line image, according to some embodiments.

FIGS. 6A and 6B are block diagrams illustrating training and ensemble modules, according to some embodiments.

FIG. 7 is a block diagram illustrating examples of variables and a corresponding variable matrix, according to some embodiments.

FIG. 8 is a flow diagram illustrating a method for determining whether an entity requesting a new electronic communication is exhibiting anomalous behavior based on a variable matrix corresponding to the entity, according to some embodiments.

FIG. 9 is a block diagram illustrating an example computing device, according to some embodiments.

### DETAILED DESCRIPTION

As the processing bandwidth of different entities increases, the amount of data available from computing systems utilized by these entities increases. Such data may be used for analysis and decision-making by the entities. The overall distribution of such data may be indicative of problems, such as errors or suspicious activity on the computing systems. Some entities accumulate and store source data with billions of attributes, with millions of new attributes being processed on a monthly, weekly, daily, etc. basis. As one specific example, an electronic communication processing system (e.g., PayPal™) may process communications for many different entities. In this specific example, a given user may access their account with the electronic processing system to initiate electronic communications with hundreds of other users per day.

In some situations, the electronic processing system analyzes one or more attributes of a given entity to determine whether the one or more attributes are abnormal for this entity (e.g., the user may be suspicious and, thus, may participate in fraudulent activity). The analysis of individual attributes, however, often results in an inaccurate depiction of the given entity's behavior. For example, if the total payment volume for a user account at a given point in time is high, this may not necessarily be indicative of anomalous (and potentially suspicious) activity for this user account. In this example, however, the change over time (e.g., a sudden drop) in the total payment volume for this user account is indicative that this account is likely suspicious (which may result in loss of resources e.g., both computational and financial) and a decrease in security. The change in one or more variables for an entity over time may be referred to as the data distribution or variable distribution for this entity. In order to obtain a more accurate depiction of anomalous behavior for a given entity, the disclosed system analyzes the overall distribution of data for the given entity to determine whether their data is exhibiting an abnormal distribution.

In many situations, however, manual visual analysis (e.g., by a security analyst) of data distributions for many entities is both slow and tedious as well as being accompanied by a high risk of user error (e.g., individuals analyzing the data distribution may miss abnormal patterns). In order to combat this risk of error, the disclosed techniques leverage machine learning techniques (e.g., using image classification models) to automatically analyze entity distribution data to identify abnormal patterns in the data's distribution. As one specific example, the disclosed techniques may convert a set of distribution data into lines within an image and leverage a convolutional neural network (CNN) to analyze the image of lines in order to identify abnormal patterns in an entities behavior based on their data distribution.

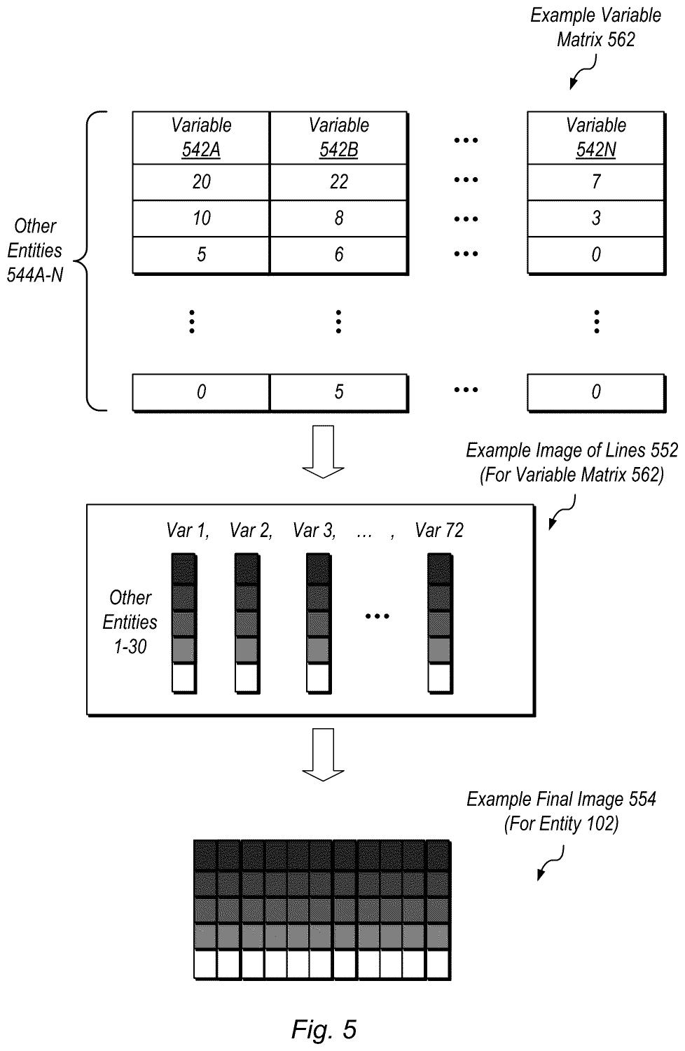

To generate images from entity distribution data for training a machine learning model to predict whether entities are exhibiting abnormal behavior, the disclosed techniques calculate variables from attributes of different entities, generate matrices from the variables (including normalizing the variables and transforming the matrices), and generate images of lines from the variable matrices. As discussed in further detail below with reference to FIG. 5, a variable matrix may include 70 different variables for a given entity calculated from attributes of the entity recorded at different intervals of time. For example, two variables may be of the same type, but are calculated for different time intervals and, therefore, have two different values for a given entity. These 70 different variables may be calculated for 30 different other entities with which the given user account is communicating (e.g., 30 different counterparties of a given user account). Once it has generated a plurality of images, the disclosed system is able to train a machine learning model on multi-dimensional data (in terms of both time and different types of variables analyzed) that includes context for how the variables of entities have changed over time, which in turn allows the system to determine whether entities are exhibiting abnormal behavior. For example, a sharp drop in a given variable might be more accurately indicative of fraud than a specific value for the given variable at a particular point in time. In addition, in response to detecting abnormal behavior in a given entity using the model trained on images of distribution data, the disclosed system performs one or more preventative actions. For example, the system may prevent the given entity from performing future actions (e.g., this entity is blocked from initiating future electronic transactions).

The efficient generation of multi-dimensional distribution data provided by the disclosed techniques may advantageously allow for training and updating of machine learning models, as discussed above, for use in predicting abnormalities in the behavior of entities requesting electronic communications. Such techniques may advantageously allow electronic communication processing systems to quickly analyze electronic communication data to identify suspicious behavior and, thereby, mitigate potential future suspicious (and potentially fraudulent) behavior. Such techniques may advantageously decrease the amount of resources (both time and computational resources) necessary to perform further risk detection as well as decreasing loss (e.g., financial, user trust, etc.) associated with suspicious electronic communications.

### Example Server System

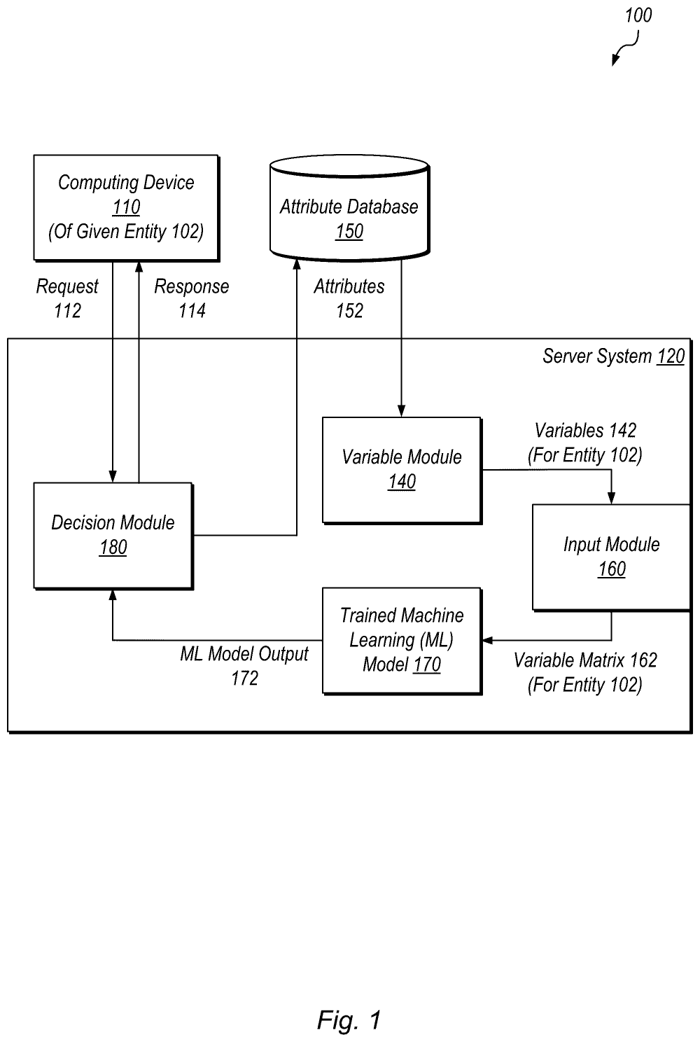

FIG. 1 is a block diagram illustrating an example system configured to generate variable matrices for use in training a machine learning model. In the illustrated embodiment, system 100 includes computing device 110, attribute database 150, and server system 120, which in turn includes variable module 140, input module 160, trained machine learning (ML) model 170, and decision module 180.

Server system 120, in the illustrated embodiment, receives a request 112 from computing device 110, and generates and transmits a response 114 to computing device 110 based on output 172 of trained ML model 170. As discussed in further detail below, the ML model output 172 may indicate that an entity 102 that submitted request 112 is suspicious. Based on this the output 172, decision module 180 may perform one or more preventative actions corresponding to entity 102. For example, the response 114 may indicate that a request 112 for an electronic transaction has been authorized, denied, or requires additional authentication or verification. As another example, response 114 may indicate that computing device 110 (or an account used by entity 102 at device 110 to submit request 112) has been blocked from submitting further requests to server system 120 indefinitely or until an additional authentication process has successfully been completed by the entity 102 utilizing computing device 110. For example, in some situations, decision module 180 may send requests for authentication factors (in response 114) to computing device 110 based on the ML model output 172. In some embodiments, the trained ML model 170 is an image classification model. For example, model 170 may be a CNN, a you only look once (YOLO) model, a vision transformer, a residual neural Network (ResNet), GoogLeNet, VGG16, etc.

In addition to generating a response 114 for request 112, decision module 180, in the illustrated embodiment, stores attributes 152 corresponding to the request 112 to attribute database 150. For example, request 112 may be for an electronic transaction and decision module 180 gathers information about the electronic transaction and stores it in database 150. In this example, the attributes may include a transaction amount, transaction timestamp, the user account requesting the transaction, a counterparty involved in the transaction, a transaction type, device information (e.g., hardware or software information for the device 110 submitting the transaction request, such as an internet protocol (IP) address), etc.

In the illustrated embodiment, in response to receiving request 112 at decision module 180, server system 120 retrieves attributes 152 from attribute database 150. In the illustrated embodiment, attributes 152 are for the given entity 102 utilizing computing device 110. For example, server system 120 may retrieve a set of attributes 152 corresponding to given entity 102 that indicate the behavior of entity 102 for the past day, month, year, etc. The attributes 152 retrieved from database 150 may be for any of various types of source data including, for example, electronic communications (e.g., transactions, data transmissions for a server network, messages, etc.), weather patterns, medical reports, etc. In the example of electronic communication data, attributes 152 may indicate which entities are involved in the electronic communications, types of information being communicated between entities, amounts of data being communicated (e.g., a transaction amount), etc.

In the illustrated embodiment, server system 120 executes variable module 140 to retrieve attributes 152 and generate variables 142 for the given entity 102. For example, variable module 140 calculates one or more variables from the attributes 152. The variables 142 calculated by variable module 140 may also be referred to as features. For example, variable module 140 may calculate features for training a machine learning model based on the attributes 152 of a plurality of different entities. In such situations, variable module 140 may calculate the features using one or more feature calculation algorithms such as, for example: total, average, median, first, last, etc. As one specific example in the context of electronic transactions, variable module 140 may calculate a total payment volume (TPV) for a user account over the past 30 days. In some situations, feature calculation algorithms may also include feature preprocessing, such as filtering algorithms. In some embodiments, variable module 140 stores determined variables 142 in association with entity 102 in a database. For example, the variables 142 calculated for entity 102 may be stored for use in training one or more machine learning models. Variable module 140 may store the variables 142 in attribute database 150 with an identifier (ID) corresponding to entity 102 or may store the variables 142 in another database (e.g., a variable database) that is separate from database 150.

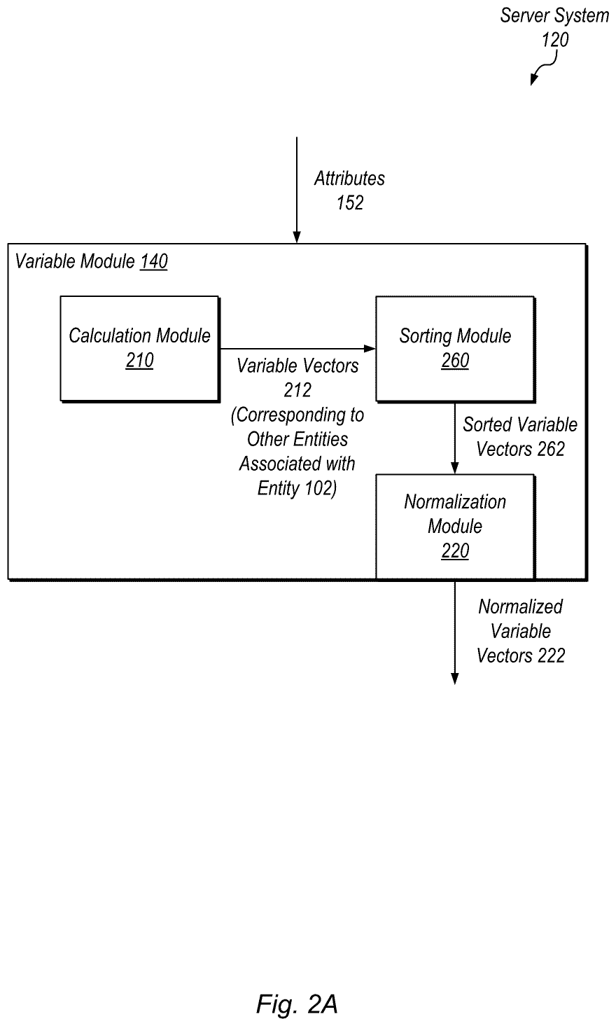

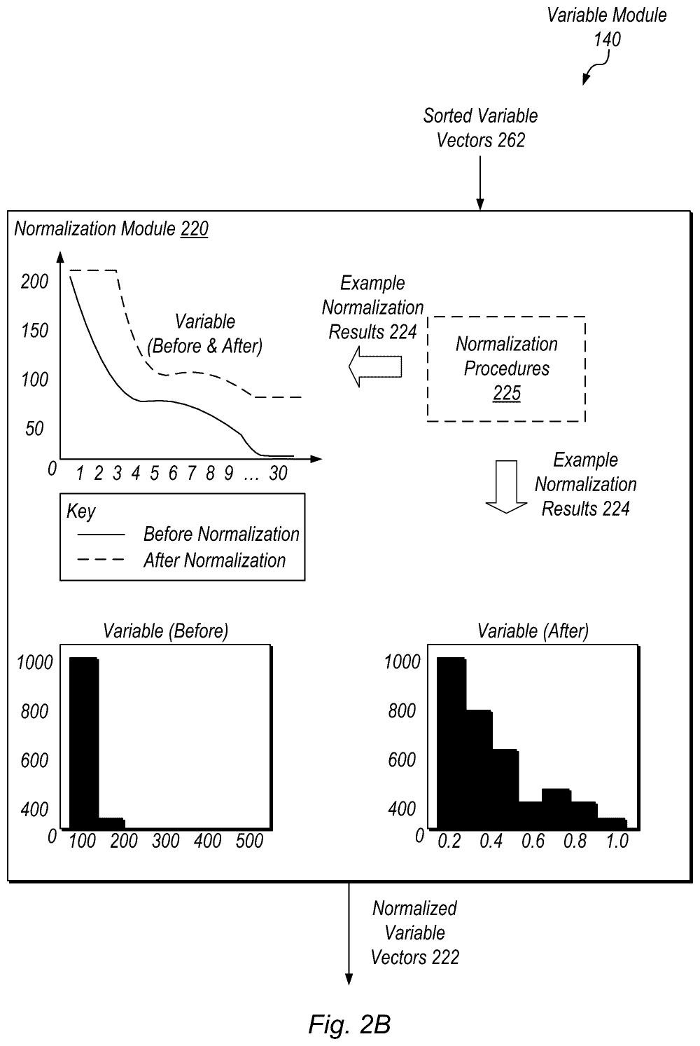

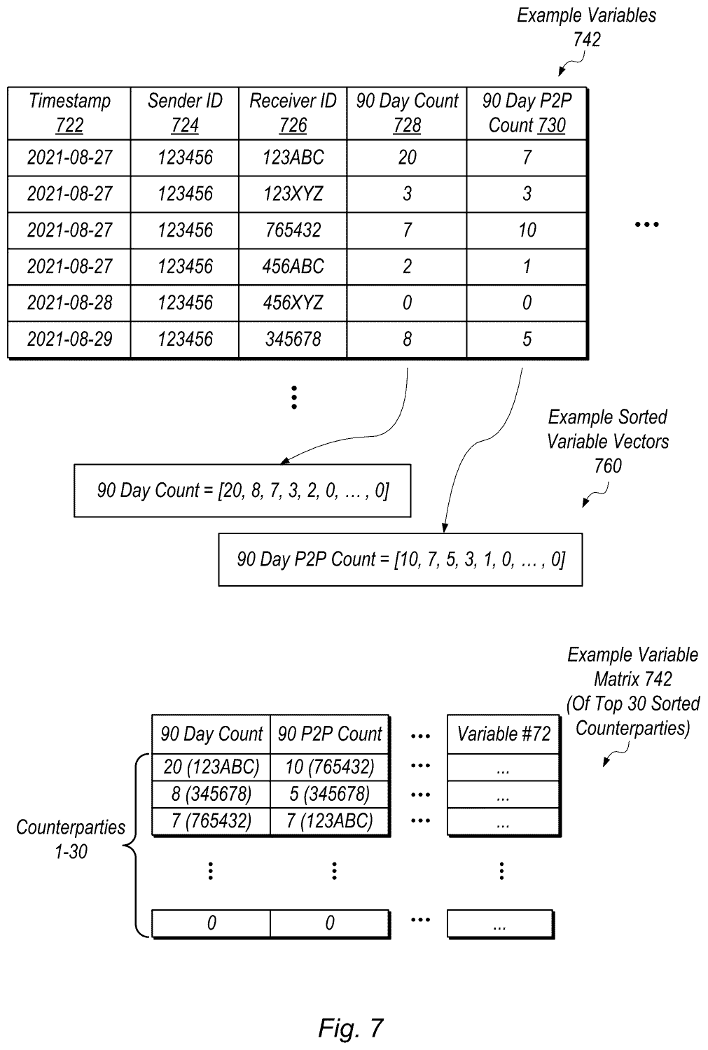

Input module 160, in the illustrated embodiment, is executed by server system 120 to generate a variable matrix 162. For example, input module 160 takes the variables 142 calculated by variable module 140 for entity 102 and places the values for these variables into a matrix whose columns correspond to different variables 142 and whose rows correspond to a plurality of other entities with which entity 102 has completed electronic communications. As one specific example, input module 160 generates a variable matrix 162 for a given user account and the variable values that are stored in matrix 162 indicate the values of variables calculated for different time intervals for 30 different counterparties with which the given user account has transacted, as discussed in further detail below with reference to FIG. 7. In this example, the columns of the matrix 162 correspond to e.g., 30, 60, and 90 day transaction counts for transactions completed between the given entity and 30 different counterparties. In the illustrated embodiment, input module 160 inputs variable matrix 162 into trained ML model 170. In some embodiments, as discussed in further detail below with reference to FIG. 2, input module 160 generates an image of lines from the variable matrix 162 and sends this image to trained ML model 170.

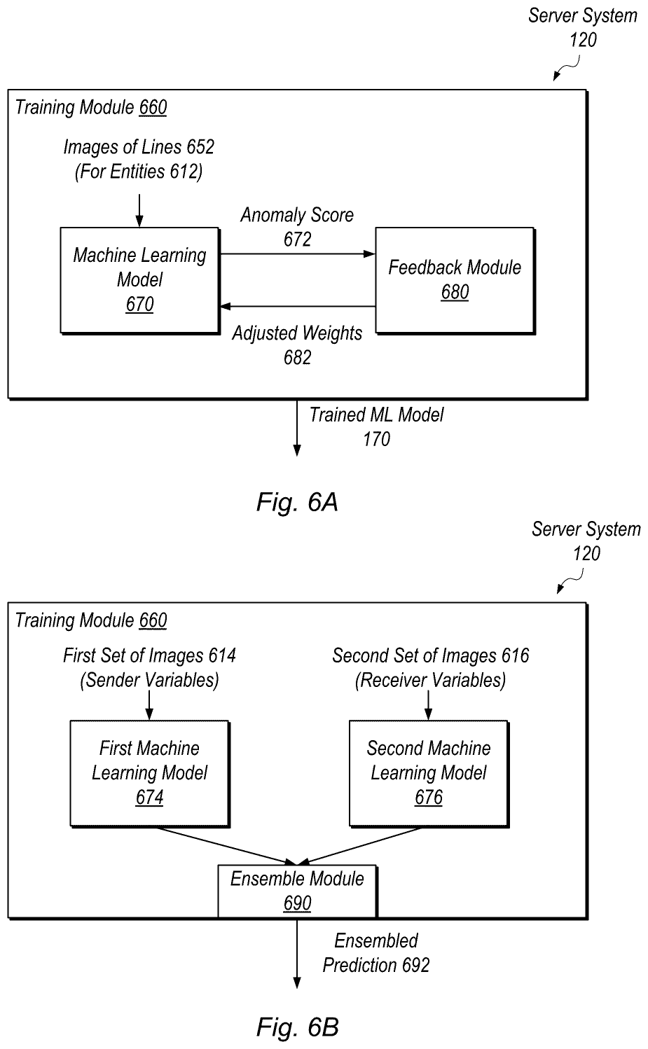

Trained ML model 170, in the illustrated embodiment, receives variable matrix 162 from input module 160 transmits output 171 based on the matrix 162 to decision module 180. In some embodiments, in addition to generating variable matrix 162, input module 160 generates an image of lines based on the variable matrix as discussed in further detail below with reference to FIGS. 2 and 5. Server system 120 then inputs this image into model 170 and model 170 generates an abnormality score based on the image of lines. In some embodiments, prior to generating output 172 based on matrix 162, server system 120 trains model 170 using a plurality of previously generated variable matrices for a plurality of different entities for which labels are known. For example, as discussed in further detail below with reference to FIGS. 6A and 6B, server system 120 may include a training module for training one or more machine learning models using labeled data. As one specific example, images of lines used to train a machine learning model may include labels indicating whether or not entities corresponding to the respective matrices are suspicious (e.g., potentially fraudulent users). Said another way, server system 120 uses its existing knowledge of a set of entities involved in prior electronic communications to train a machine learning model to predict whether new requests initiated by the set of entities (or indeed other entities) are anomalous and whether or not preventative actions should be performed. As another specific example, the entity data being used to generate images of lines to train a machine learning model may be data indicating transmissions between different servers (examples of entities) of a network of servers and the corresponding known labels for the entities indicate whether the servers are offline (or malfunctioning in some way, such as dropping more than a threshold number of packets during a transmission).

In this disclosure, various “modules” operable to perform designated functions are shown in the figures and described in detail (e.g., variable module 140, input module 160, decision module 180, etc.). As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC.

### Example Vector Generation

Turning now to FIG. 2A, a block diagram is shown illustrating example variable and input modules. In the illustrated embodiment, server system 120 includes variable module 140, which in turn includes calculation module 210, sorting module 260, and normalization module 220.

Variable module 140, in the illustrated embodiment, executes calculation module 210 to generate variable vectors 212 corresponding to one or more other entities associated with entity 102. In various embodiments, variable module 210 calculates variables for a plurality of other entities associated with entity 102 and places these variables in vectors for entity 102. A given variable calculated for entity 102 and a plurality of other entities is stored in a single vector. As one specific example, the variable vector 212 is calculated for multiple counterparties participating in electronic transactions with a user account of entity 102 and this vector includes values such as a total transaction count between each of the other entities and entity 102 in the past 5 days, the total transaction count between each of the other entities and entity 102 in the past 30 days, a total transaction amount for transactions between each of the other entities and entity 102 in the past 15 days, a total transaction amount for transactions between each of the other entities and entity 102 in the past 30 days, etc.

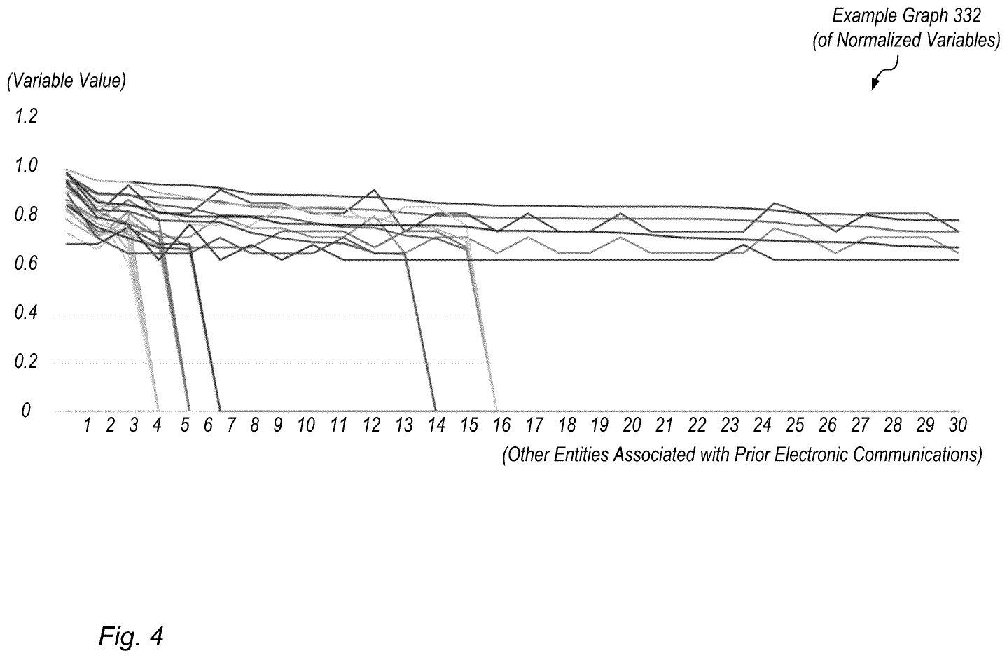

As on example, a given vector for entity 102 stores values of a variable, calculated by module 210, that indicate the total transaction count in the past 90 days for entity 102 and 80 other entities (e.g., 80 counterparties of entity 102). The vector for entity 102 in this specific example resembles the following: total_count_90d=[0, 8, 8, 8, 0, 20, 4, 3, 3, 5, 9, 2, 3, 1, 1, 4, 1, 8, 15, 0, . . . , 7]. For example, in order to calculate the second variable value (“8”) shown in this example vector, calculation module 210 determines a total number of electronic communications completed between entity 102 and a second entity (e.g., a second counterparty of entity 102) during the past 90 days. Similarly, in this example, calculation module 210 also determines a total number of electronic communications completed between entity 102 and a sixth other entity (e.g., a sixth counterparty of entity 102) during the past 90 days. FIG. 4, discussed in further detail below, includes a graph of several example variables that may be calculated by calculation module 210.

Sorting module 260, in the illustrated embodiment, receives the variable vectors 212 from calculation module 210 and sorts the variables stored in these vectors according to their values. In some embodiments, sorting module 260 sorts the values in a variable vector from largest variable value to smallest variable value within each vector. The specific vector example discussed above that stores values for a variable that indicates the total count for the past 90 days resembles the following after its values are sorted by sorting module 260: The sorted vector for entity 102 in this specific example resembles the following: total_count_90d=[20, 15, 9, 8, 8, 8, 8, 7, 5, 4, 4, 3, 3, 3, 2, 1, 1, 1, 0, 0, 0, . . . , 0]. In other embodiments, the sorting module 260 sorts values for a variable vector from smallest to largest.

In some embodiments, in addition to sorting values for a given variable within a corresponding vector, sorting module 260 selects a subset of the set of values calculated by variable module 140 in order to reduce the number of values stored in the vector. For example, after sorting the 80 values stored in a given vector, sorting module 260 selects the largest 30 values for inclusion in a reduced vector and discards the other 50 values. In some embodiments, the number of variable values selected by sorting module 260 is based on a counterparty threshold. For example, sorting module 260 may select the top 30 counterparties for their values to be included in a variable vector e.g., for use in training a machine learning model to predict behavioral anomalies as discussed in further detail below with reference to FIGS. 6A and 6B. In other embodiments, the number of variable values selected by sorting module 260 may be based on non-zero variable values. For example, sorting module 260 may select only the first 18 values included in the total_count_90d vector discussed above since the rest of the values in this example variable matrix are zero (i.e., entity 102 did not transact with the counterparties corresponding to these zero values during the past 90 days) as these values are unlikely to help in training a model to identify behavior anomalies for entity 102. Sorting module 260 sends the sorted, reduced vectors to normalization module 220.

Normalization module 220, in the illustrated embodiment, receives variable vectors 212 from sorting module 260 and generates vectors with normalized variables 222. In order to prevent bias of a machine learning model when training using variable vectors 262, normalization module 220 normalizes the values stored in vectors 262. For example, since the data values in vectors 262 cover a wide range, this might cause a machine learning model to place too much focus on the larger values in the vectors which in turn would skew the predictions of the model during execution (after training). In addition and as a specific example, a high dollar amount for a transaction for a given counterparty of entity 102 does not necessarily indicate anomalous behavior, but rather the difference over time (e.g., a large drop in amount from 30 days to 90 days) for a given counterparty might be indicative of anomalous (and potentially fraudulent) behavior. As such and as discussed in further detail below with reference to FIG. 2B, normalization module 220 normalizes the values stored in respective variable vectors 262 and sends these normalized variable vectors 222 to input module 160.

In FIG. 2B, variable module 140 includes normalization module 220, which executes several normalization procedures in order to generate example normalization results 224. In the illustrated embodiment, normalization module 220 receives variable vectors 262 and outputs normalized variable vectors 222. For example, normalization module 220 executes one or more normalization procedures 225 to normalize values of a given variable stored within a given vector.

For example, normalization module 220 may perform one or more types of the following types of normalization procedures in order to standardize variable values within a given range: min-max, z-score, log transformation, etc. As another example, normalization module 220 may apply a pairwise value comparison to a global distribution of the values stored in a given vector to find out each values relative ranking within the global distribution. Based on this comparison, normalization module 220 transforms each value in the given vector to the same range (e.g., transform the values to a scale ranging from 0 to 1). As one specific example, normalization module 220 may calculate the upper value for a given vector by executing the following equation:

$${upper}_{value} = max ( p 99 , avg ( var ) , 1.5 * stddev ( var ) )$$

In the equation above, p99 represents the 99% percentile, indicating that 99% of the upper values are below the p99 value. The “var,” in the equation is the vector, e.g., one of variable vectors 262. For example, if we have a vector call total_count_90d=[1, 2, 3, . . . 99, 100] and p99 of it=99, then the average value of the variable vector below the 99^{th} percentile (i.e., below the value 99) is 50.5 and the result of 1.5*stddev(variable) is 1.5*29.3 which is 43.95. In this example, the equation becomes upper value=maximum (50.5, 43.95). In this example, the upper value is the maximum of the two values, which is 50.5.Based on the calculated upper value, normalization module 220 calculates a normalized version of each value stored in a given variable vector 262. For example, normalization module 220 executes the following equation:

$${Variable}_{norm} = \frac{ln ( var ) - ln ( min )}{ln {upper}_{value} - ln ( min )}$$

Continuing with the example above, in which the upper value is 50.5, the minimum value in the variable vector “var” that includes values [1, 2, 3, . . . , 99, 100] will be “1.” Thus, the equation above for calculating the normalized value of the last element in the vector (i.e., value “100”) becomes variable_norm=(ln(100)−ln(1))/(ln(50.5)−ln(1)).

In FIG. 2B, an example line graph of values of a given variable both before (solid line) and after (dotted line) normalization are shown as well as an example block graph showing the data distribution of a given variable both before (the block graph shown on the bottom left portion of the figure) and after (the block graph shown on the bottom right portion of the figure) normalization. The horizontal axis of the example line graph includes values 0 through 30 for the 30 counterparties corresponding to the values of a given sorted variable vector 262, while the vertical axis of the example line graph includes values 0 through 200 for the values of the given variable. Similarly, the block graphs shown at the bottom portion FIG. 2B illustrate data distribution in the values of a given variable both before and after normalization. The x-axes in the graphs of FIG. 2B represent respective values in a given variable vector, while the y-axes represent the count number of elements in the given variable vector.

### Example Image Generation

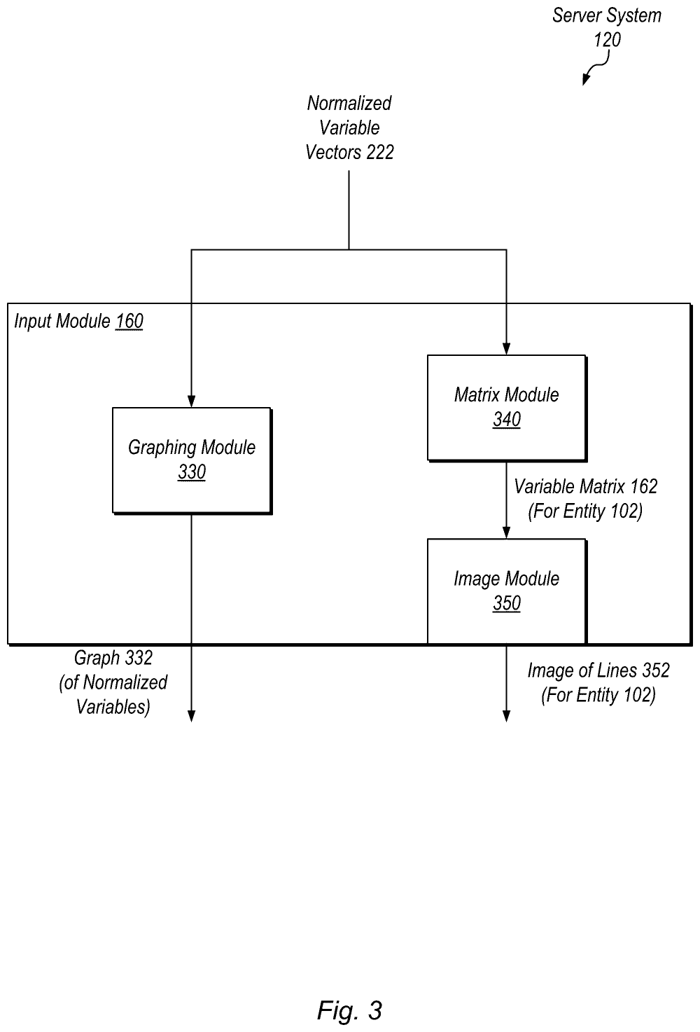

Turning now to FIG. 3, an example input module is shown. In the illustrated embodiment, server system 120 includes input module 160, which in turn includes graphing module 330, matrix module 340, and image module 350. In the illustrated embodiment, normalized variable vectors 222 are input to both graphing module 330 and matrix module 340. In some embodiments, image module 350 generates an image 352 of lines from the normalized variable vectors 222 without using a variable matrix 162. In other embodiments, image module 350 generates the image 352 of lines from variable matrix 162.

Matrix module 340, in the illustrated embodiment, receives normalized variable vectors 222 and generates a variable matrix 162 for an entity 102 corresponding to the normalized variable vectors 222. For example, matrix module 340 places the vectors in a matrix where each row of the matrix is made up of a normalized variable vector. Matrix module 340 then transposes the matrix such that the rows of the matrix correspond other entities (e.g., counterparties) and the columns correspond to the variable values stored in the vectors. For example, a given entry (i.e., variable value) in the variable matrix has a corresponding counterparty and a corresponding variable as discussed in further detail below with reference to FIG. 5. As one specific example, prior to transformation by matrix module 340, a variable matrix is a 72×30 matrix. In this specific example, after transformation the matrix is a 30×72 matrix, where rows of the matrix correspond to different counterparties and each column of the matrix corresponds to a different variable (which in turn corresponds to a different vector).

Image module 350, in the illustrated embodiment, receives variable matrix 162 for entity 102 from matrix module 340. In some embodiments, image module 350 generates an image 352 of lines for entity 102 based on the variable matrix 162. For example, image module 350 generates an image whose pixels correspond to the variable values stored in each entry of variable matrix 162. In this example, each column of variable matrix 162 is used to generate a given “line” in the image 352 of lines as shown in FIG. 5 and discussed in further detail below. In this example, each value in matrix 162 corresponds to a colored pixel in the image generate by image module 350. Further in this example, the size (in terms of pixels) of the image 352 of lines output by image module 350 is the same as the size of the variable matrix 162. As one specific example, a variable matrix 162 of size 30×72 would result in an image of size 30 pixels×72 pixels. In other embodiments, image module 350 generates image 352 of lines directly from normalized variable vectors 222 without using a variable matrix 162.

Graphing module 330, in the illustrated embodiment, generates a graph 332 of normalized values included in a plurality of normalized variable vectors 222. For example, graphing module 330 plots the values of the vectors 222 by setting an x-axis of the graph 332 as the other entities corresponding to the values in the vectors 222. Further in this example, graphing module 330 sets the y-axis of the graph 332 to indicate the values of the variable, such that the different lines plotted in the graph correspond to the different variables represented by normalized variable vectors 222. An example graph 332 generated by graphing module 330 is shown in FIG. 4 and discussed in detail below. In some embodiments, input module 160 provides this graph 332 to decision module 180 (shown in FIG. 1). For example, decision module 180 may compare the graph 332 with a prediction output by trained ML model 170 prior to making a final decision for a request 112. In some embodiments, input module 160 sends the graph 332 to a training module (e.g., training module 660 shown in FIGS. 6A and 6B and discussed in detail below) executed by server system 120 for use in machine learning training.

### Example Variable Graph

FIG. 4 is a diagram illustrating an example variable graph 332 for a given entity 102. The graph 332 includes a y-axis indicating the values of a plurality of different variables, while the x-axis indicates identifiers of other entities associated with prior electronic communication (e.g., counterparties of a given entity 102 for which graph 332 has been generated). In FIG. 4, each line shown in the graph 332 represents values of 30 different entities for a given variable. For example, the lines in graph 332 correspond to one or more of the following variables determined for time intervals of 7, 30, and 90 days, respectively: total transaction amount, total transaction count, total person-to-person transaction amount, total merchant transaction count, total friends and family transaction count, non-person-to-person transaction count and amount, etc.

In the illustrated embodiment, several of the lines included in graph 332 include a sharp drop in variable value for a given entity 102 between two different other entities. For example, one line in graph 332 showing the values of a given variable (e.g., total transaction volume) for entity 102 includes a sharp drop between other entities 13 and 14 (the line that drops down to a variable value of 0 at entity 14 in the graph). In this example, the sharp drop for this value for entity 102 may be indicative of anomalous behavior for this entity. The variable graph shown in FIG. 4 indicates the trend of changes among different counterparties, for example. This same trend graph, however, could be applied to any of various use cases. For example, for a sender entity, a graph similar to the one shown in FIG. 4 might show how many authentications counterparties of this sender have successfully completed or not completed in the past 3, 7, 30 etc. days. In this example, the x-axis would represent the counterparties having a large number of authentications (e.g., the 30 counterparties having the highest number of authentications relative to other counterparties in a set of 70 counterparties) and the y-axis would represent the normalized value of the total count of successful and not successful authentications of the counterparties.

### Example of Variable Matrix

FIG. 5 is a block diagram illustrating an example variable matrix and an example line image. In the illustrated embodiment, example variable matrix 562 includes columns for variables 542A-N corresponding to various other entities 544A-N. For example, in matrix 562 the variable value for variable 542A is 20. In this example, variable value 20 corresponds to other entity 544B. As another example, in matrix 562 the variable value for variable 542B is 22. In this example, variable value 22 corresponds to entity 544A. In the illustrated embodiment, an example image 552 of lines is shown which is generated (by image module 350 shown in FIG. 3) from variable matrix 562. For example, a first pixel of image 552 of lines is a very dark grey pixel (almost black) in the first line of the image and this first pixel corresponds to the value of “20” which corresponds to variable 542A (as shown in variable matrix 562). In some embodiments in order to generate a final cohesive image, image module 350 shown in FIG. 3 combines the lines of image 552 shown in the middle portion of FIG. 5 to generate a final image 554 for an entity 102. As discussed above, the values from matrix 562 are mapped to the colored pixels (e.g., in the red, green, blue (RGB) scale) in an image whose dimensions correspond to the size of the matrix 562.

### Example Machine Learning

FIGS. 6A and 6B are block diagrams illustrating training and ensemble modules. In both FIGS. 6A and 6B, a training module 660 included in server system 120 is shown, while in FIG. 6A example training of a machine learning model 670 is shown and in FIG. 6B both example training and example ensembling for machine learning are shown.

In FIG. 6A, training module 660 includes a machine learning model 670 and a feedback module 680. Training module 660 inputs images 652 of lines for a plurality of different entities 612 into machine learning model 670. Machine learning model 670, in the illustrated embodiment, outputs anomaly scores 672 for respective images 652. For example, an anomaly score 672 output by the model 670 may be a probability value indicative of the models confidence that an image should be classified as one value or another. In this example, the anomaly score 672 is a value between 0 and 1, with the value 0 indicating that an image 652 is not anomalous and a 1 indicating that an image 652 is anomalous (e.g., that the entity corresponding to this image is suspicious). Model 670 generates the anomaly score by comparing the input data (e.g., in this example, images of lines) to a learned representation of normal patterns. For example, during the training process, the model learns to recognize and represent typical patterns in the data. When given a new input, the model calculates the discrepancy between the input and the learned representation of normal patterns, resulting in an anomaly score. In some embodiments, higher anomaly scores indicate a greater deviation from the learned normal patterns.

Based on these scores 672, feedback module 680 inputs adjusted weights 682 to machine learning model 670 (to replace its current weights). Training module 660 then executes the machine learning model 670 but with the adjusted weights generated by feedback module 680. For example, training module 660 re-inputs images 652 of lines into the machine learning model 670 with adjusted weights and feedback module 680 observes new anomaly scores output by the adjusted model.

If feedback module 680 is satisfied with the new anomaly scores output by the adjusted model, then training module 660 outputs a trained ML model 170 (as shown in FIG. 1 and discussed above). For example, feedback module 680 may compare the anomaly scores 672 with known anomaly labels for each entity 612 corresponding to each of images 652. As one specific example, if feedback module 680 has a label indicating that a given entity 612 is anomalous (this entity has been assigned an anomalous label based on its prior behavior), then an anomaly score 672 output by model 670 indicating a prediction that the given entity is anomalous would be deemed accurate and feedback module 680 may not adjust the weights of the model 670. If, however, the anomaly score 672 output by model 670 is in contradiction with a known anomalous label for the given entity, then feedback module 680 will adjust the weights of model 670. As one specific example, if an entity is assigned an anomalous label of “1” and machine learning model 670 outputs an anomaly score of “0.8” for this entity based on the image 652 of lines corresponding to this entity, then feedback module 680 may deem this prediction score satisfactory (since the score is close to the known label) and will not perform further training on model 670 at that time.

In FIG. 6B, a training module 660 is shown that includes a first machine learning model 674, a second machine learning model 676, and an ensemble module 690. In the illustrated embodiment, training module 660 trains a first machine learning model 674 using a first set of images 614 of lines that are generated based on sender variables. For example, the images 614 are generated from variables that are generated from attributes of only an entity initiating an electronic communication. In contrast, in the illustrated embodiment, training module 660 also trains a second machine learning model 676 using a second set of images 616 generated from only receiver variables (e.g., variables generated from attributes of only the entity on the receiving end of the electronic communication). In some embodiments, the two machine learning models 674 and 676 are the same type of model. For example, the two models may be image classification models, such as CNNs. In other embodiments, the two machine learning models 674 and 676 are two different types of models. For example, the first model 674 may be a CNN, while the second model 676 may be a ResNet model and vice versa.

Ensemble module 690, in the illustrated embodiment, combines the first model 674 and the second model 676 after training module 660 is finished with training. For example, ensemble module 690 may combine the output of two models 674 and 676 to generate an ensembled predicted anomaly score. As one specific example, models 674 and 676 are gradient boosting algorithms. In the illustrated embodiment, during training of models 674 and 676, ensemble module 690 combines the scores output by these models for various different images 614 and 616 and compares the combined score with known labels for these images. During execution of the ensemble module 690 (after training of the two models is complete in order to predict whether an unlabeled entity is anomalous or not), an image generated from the sender variables (e.g., the variables of an unlabeled entity) is input into model 674 while an image generated from receiver variables (e.g., the variables of a plurality of entities the unlabeled entity has interacted with) is input into model 676. Based on the output from models 674 and 676 for the images corresponding to the unlabeled entity, ensemble module 690 generates an ensembled prediction regarding whether the unlabeled entity is exhibiting anomalous behavior.

### Example Variable Matrix Generation

Turning now to FIG. 7, a block diagram is shown illustrating examples of variables and a corresponding variable matrix. In the illustrated embodiment, a variable matrix of example variables, example sorted vectors generated from the example variables, and an example matrix generated from the sorted variable vectors are shown. The example variables shown in the illustrated embodiment include a 90 day count variable 728 and a 90 day person-to-person count variable 730. Further, the top portion of FIG. 7 shows three different attributes corresponding to the calculated variables 728 and 730. For example, the three example attributes shown in FIG. 7 are a timestamp attribute 722, a sender ID attribute 724, and a receiver ID attribute 726. As discussed above with reference to FIG. 1, server system 120 executes variable module 140 to retrieve attributes 152 from attribute database 150. For example, attribute module 140 may retrieve attribute values for the timestamp attribute 722, the send ID attribute 724, and the receiver ID attribute 726 from attributes database 150. In various embodiments, server system 120 identifies attributes from different entity requests, such as request 112, and stores these attributes 152 in database 150.

In the illustrated embodiment, two example sorted variable vectors 760 are shown that are generated from variables 728 and 730, respectively. For example, the first sorted variable vector shows a vector storing descending-order sorted values for a 90 count variable 728, while the second sorted variable vector shows a vector storing descending-order sorted values for a 90 day person-to-person count variable 730. These two vectors (as well as 70 other sorted variable vectors generated for an entity corresponding to sender ID 123456 and for 30 different counterparties of the sender corresponding to sender ID 123456) are stored in an example variable matrix 742 and the matrix is transposed such that the dimensions are 30×72 (counterparty by variable). For example, variable matrix 742 includes variable values for 72 different variable vectors for the top 30 counterparties. Because the 72 variable vectors are sorted in descending order according to their values, when they are placed in a matrix together, their corresponding counterparties may not match. For example, the counterparty corresponding to the first entry “20” in the first column of the matrix, which is variable vector 90 day count, is identifier “123ABC.” In contrast, the counterparty corresponding to the first variable value entry “10” in the second column of the matrix, which is variable vector 90 P2P count, is identifier “765432.” As discussed above, sorting variable values in descending order may advantageously allow for identification of big changes in the behavior of entities (i.e., if there is a large drop in a variable value within a vector).

### Example Method

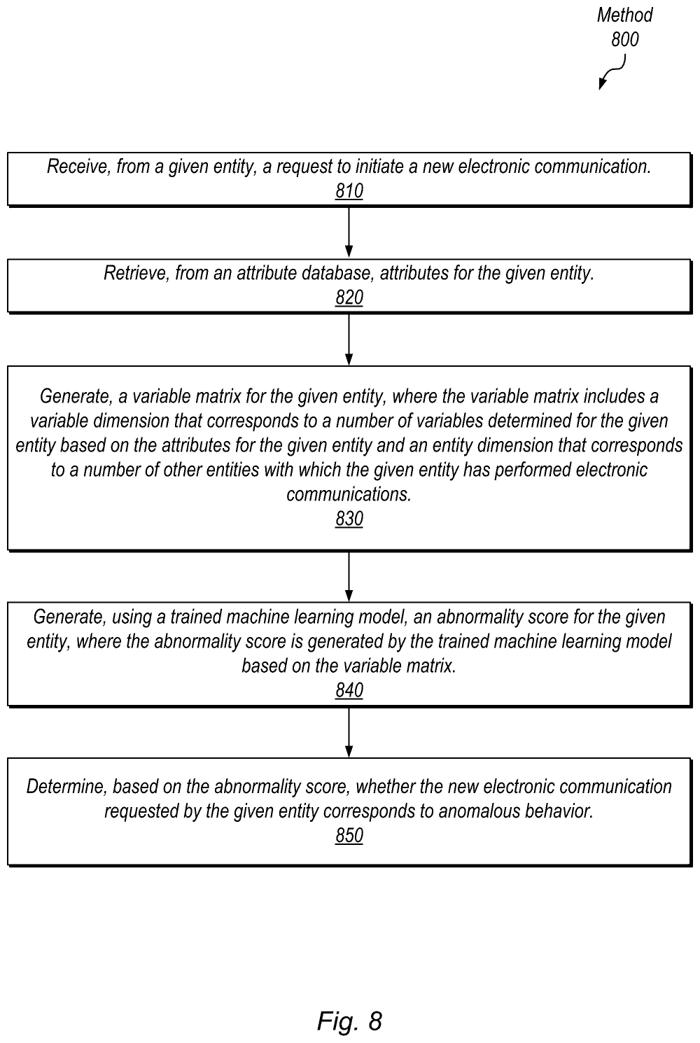

FIG. 8 is a flow diagram illustrating a method for determining whether an entity requesting a new electronic communication is exhibiting anomalous behavior based on a variable matrix corresponding to the entity, according to some embodiments. The method 800 shown in FIG. 8 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, server system 120 performs the elements of method 800.

At 810, in the illustrated embodiment, a server system receives, a request to initiate a new electronic communication from a given entity. In some embodiments, the request to authorize the action is a request to authorize communication between two or more servers in a network of servers, where the given entity is a server included in the network of servers, and where the other entities are one or more other servers included in the network of servers. For example, the first server may be located in a first geographical region (e.g., North America), while the second server may be located in a second, different geographical region (e.g., Europe).

At 820, the server system retrieves attributes for the given entity from an attribute database. In some embodiments, the server system calculates, based on retrieving attributes from the attribute database, a plurality of variables for the given entity, where the calculating includes determining one or more variables for two or more different intervals of time, and where the variables included in the variable matrix include one or more of the following types of variables: transaction count, transaction amount, transaction type count, transaction type amount. In some embodiments, the server system stores the plurality of variables in a variable database in association with an identifier of the given entity.

At 830, the server system generates a variable matrix for the given entity, where the variable matrix includes a variable dimension that corresponds to a number of variables determined for the given entity based on the attributes for the given entity and an entity dimension that corresponds to a number of other entities with which the given entity has performed electronic communications. In some embodiments, generating the variable matrix for the given entity is performed by calculating a plurality of variables based on the attributes for the given entity. In some embodiments, generating the variable matrix for the given entity is performed by generating a graph of the plurality of variables, where a first dimension of the graph indicates the other entities and a second dimension of the graph indicates values of the plurality of variables, and where lines connecting points on the graph correspond to different ones of the plurality of variables. In some embodiments, generating the variable matrix for the given entity is performed by generating, based on the graph of the plurality of variables, the variable matrix for the given entity, where the lines connecting points on the graph represent different ones of the plurality of variables, and where columns of the variable matrix correspond to the lines of the graph.

In some embodiments, generating the variable matrix includes transforming, prior to inputting the variable matrix into the trained machine learning model, the variable matrix, such that columns of the variable matrix correspond to the variable dimension and rows of the variable matrix correspond to the entity dimension. In some embodiments, generating the variable matrix includes normalizing, by the server system, variable values included in the transformed variable matrix such that the trained machine learning model assigns equal weight to different entities corresponding to variable having different values. For example, normalizing variable values prevents or reduces bias in the trained machine learning model for entities having the largest variable values. In some embodiments, the server system sorts variables included in the variable matrix in descending order from largest variable value to smallest variable value.

At 840, the server system generates, using a trained machine learning model, an abnormality score for the given entity, where the abnormality score is generated by the trained machine learning model based on the variable matrix. In some embodiments, the trained machine learning model is an image classification model. For example, the image classification model may be a CNN, a you only look one (YOLO) real-time object detection model, a ResNet, etc. In some embodiments, the server system generates, based on the variable matrix, an image of lines, where the lines correspond to columns of the variable matrix which correspond to the variables determined for the given entity. In some embodiments, generating the abnormality score for the given entity based on the variable matrix includes inputting the image of lines into the image classification model.

In some embodiments, the server system trains a first machine learning model using a first set of variable matrices and a second machine learning model using a second, different set of variable matrices, where the first set of variable matrices includes variables for a sender and a receiver in respective electronic communications, and where the second, different set of variable matrices includes variables for a sender and not a receiver in respective electronic communications. In some embodiments, the server system generates a combined machine learning model by ensembling the first and second machine learning models, where the inputting and the determining are performed for other new electronic communications using the combined machine learning model.

In some embodiments, the server system compares the graph of the set of variables with the output of the trained machine learning model for the given variable matrix, where the determining is further performed based on the comparing, and where the comparing includes identifying whether the graph includes jumps for one or more variables between points in the graph corresponding to one or more other entities.

At 850, the server system determines, based on the abnormality score, whether the new electronic communication requested by the given entity corresponds to anomalous behavior. In some embodiments, the server system performs, based on determining that the new electronic communication requested by the given entity corresponds to anomalous behavior, one or more preventative actions with respect to the given entity requesting to initiate the new electronic communication. For example, the server system may prevent an account of the given entity from performing future, potentially fraudulent electronic transactions. In some embodiments, the electronic communications are electronic transactions between the given entity that is a user having a user account with the server system and other entities that are counterparties with which the user account is performing electronic transactions, and where the abnormality score output by the trained machine learning model for the new electronic communication corresponds to a jump in one or more variables for the user account over a given time interval.

In some embodiments, the disclosed techniques identify, using an image classification model, sharp drops in one or more variables of a given entity over different intervals of time. For example, the machine learning model may identify drops in the total payment volume of a given user account over the span of a month. In some embodiments, a plurality of variables included in the variable matrix include variables for the user and the counterparties calculated for different time intervals, and where the plurality of variables include one or more variable types of the following types of variables: transaction amount, transaction count, transaction type, internet protocol (IP) address of devices involved in transactions, hardware attributes of computing devices involved in electronic transactions, account login frequency, transaction date, and transaction timestamp.

### Example Computing Device

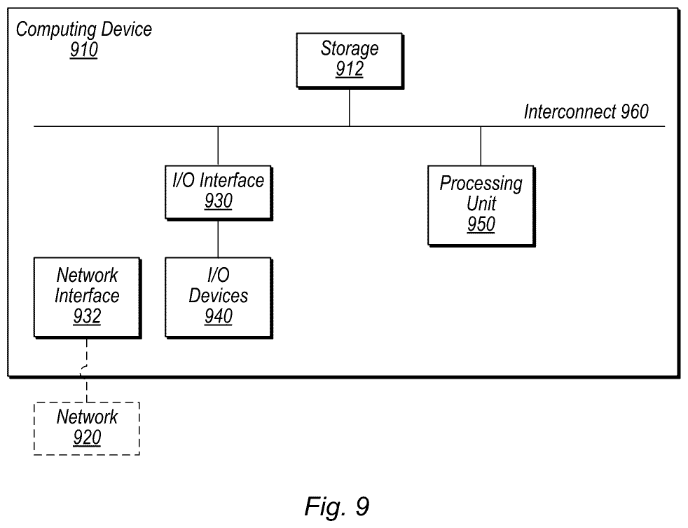

Turning now to FIG. 9, a block diagram of one embodiment of computing device 910 (which may also be referred to as a computing system) is depicted. Computing device 910 may be used to implement various portions of this disclosure. Computing device 910 may be any suitable type of device, including, but not limited to, a personal computer system, desktop computer, laptop or notebook computer, mainframe computer system, web server, workstation, or network computer. The server system 120 and the computing device 110 shown in FIG. 1 and discussed above are examples of computing device 910. As shown, computing device 910 includes processing unit 950, storage 912, and input/output (I/O) interface 930 coupled via an interconnect 960 (e.g., a system bus). I/O interface 930 may be coupled to one or more I/O devices 940. Computing device 910 further includes network interface 932, which may be coupled to network 920 for communications with, for example, other computing devices.

In various embodiments, processing unit 950 includes one or more processors. In some embodiments, processing unit 950 includes one or more coprocessor units. In some embodiments, multiple instances of processing unit 950 may be coupled to interconnect 960. Processing unit 950 (or each processor within 950) may contain a cache or other form of on-board memory. In some embodiments, processing unit 950 may be implemented as a general-purpose processing unit, and in other embodiments it may be implemented as a special purpose processing unit (e.g., an ASIC). In general, computing device 910 is not limited to any particular type of processing unit or processor subsystem.

Storage subsystem 912 is usable by processing unit 950 (e.g., to store instructions executable by and data used by processing unit 950). Storage subsystem 912 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 912 may consist solely of volatile memory, in one embodiment. Attribute database 150, discussed above with reference to FIG. 1 is one example of storage subsystem 912. Storage subsystem 912 may store program instructions executable by computing device 910 using processing unit 950, including program instructions executable to cause computing device 910 to implement the various techniques disclosed herein.

I/O interface 930 may represent one or more interfaces and may be any of various types of interfaces configured to couple to and communicate with other devices, according to various embodiments. In one embodiment, I/O interface 930 is a bridge chip from a front-side to one or more back-side buses. I/O interface 930 may be coupled to one or more I/O devices 940 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

The present disclosure includes references to “an embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise.

Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]-is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
receiving, by a server system from a given entity, a request to initiate a new electronic communication;
retrieving, by the server system from an attribute database, attributes for the given entity;
generating, by the server system, a variable matrix for the given entity, wherein the variable matrix includes a variable dimension that corresponds to a number of variables determined for the given entity based on the attributes for the given entity and an entity dimension that corresponds to a number of other entities with which the given entity has performed electronic communications;
generating, by the server system using a trained machine learning model, an abnormality score for the given entity, wherein the abnormality score is generated by the trained machine learning model based on the variable matrix; and
determining, by the server system based on the abnormality score, whether the new electronic communication requested by the given entity corresponds to anomalous behavior.

2. The method of claim 1, wherein generating the variable matrix for the given entity is performed by:
calculating, based on the attributes for the given entity, a plurality of variables;
generating a graph of the plurality of variables, wherein a first dimension of the graph indicates the other entities and a second dimension of the graph indicates values of the plurality of variables, and wherein lines connecting points on the graph correspond to different ones of the plurality of variables; and
generating, based on the graph of the plurality of variables, the variable matrix for the given entity, wherein the lines connecting points on the graph represent to different ones of the plurality of variables, and wherein columns of the variable matrix correspond to the lines of the graph.

3. The method of claim 1, wherein generating the variable matrix includes:
transforming, prior to inputting the variable matrix into the trained machine learning model, the variable matrix, such that columns of the variable matrix correspond to the variable dimension and rows of the variable matrix correspond to the entity dimension; and
normalizing, by the server system, variable values included in the transformed variable matrix such that the trained machine learning model does not include a bias for entities having the largest variable values.

4. The method of claim 1, further comprising:
performing, by the server system based on determining that the new electronic communication requested by the given entity corresponds to anomalous behavior, one or more preventative actions with respect to the given entity requesting to initiate the new electronic communication.

5. The method of claim 1, further comprising:
sorting, by the server system, variables included in the variable matrix in descending order from largest variable value to smallest variable value.

6. The method of claim 1, wherein the trained machine learning model is an image classification model, the method further comprising:
generating, by the server system based on the variable matrix, an image of lines, wherein the lines correspond to columns of the variable matrix which correspond to the variables determined for the given entity, and wherein generating the abnormality score for the given entity based on the variable matrix includes inputting the image of lines into the image classification model.

7. The method of claim 1, wherein the electronic communications are electronic transactions between the given entity that is a user having a user account with the server system and other entities that are counterparties with which the user account is performing electronic transactions, and wherein the abnormality score output by the trained machine learning model for the new electronic communication corresponds to a jump in one or more variables for the user account over a given time interval.

8. The method of claim 7, wherein a plurality of variables included in the variable matrix include variables for the user and the counterparties calculated for different time intervals, and wherein the plurality of variables include one or more variable types of the following types of variables: transaction amount, transaction count, transaction type, internet protocol (IP) address of devices involved in transactions, hardware attributes of computing devices involved in electronic transactions, account login frequency, transaction date, and transaction timestamp.

9. The method of claim 1, further comprising:
training, by the server system, a first machine learning model using a first set of variable matrices and a second machine learning model using a second, different set of variable matrices, wherein the first set of variable matrices includes variables for a sender and a receiver in respective electronic communications, and wherein the second, different set of variable matrices includes variables for a sender and not a receiver in respective electronic communications; and
generating, by the server system, a combined machine learning model by ensembling the first and second machine learning models, wherein generating the abnormality score and the determining are performed for other new electronic communications using the combined machine learning model.

10. A non-transitory computer-readable medium having instructions stored thereon that are executable by a server system to perform operations comprising:
receiving, from a given entity, a request to initiate an electronic communication;
retrieving, from a variable database, variables for the given entity and variables for a plurality of other entities with which the given entity has performed electronic communications;
generating a variable matrix for the given entity, wherein the variable matrix includes a variable dimension that corresponds to a number of variables determined for the given entity based on the variables for the given entity and an entity dimension that corresponds to a number of the plurality of other entities;
generating, based on the variable matrix, an image of lines, wherein the lines correspond to columns of the variable matrix which correspond to the variables determined for the given entity;
inputting the image of lines into a trained image classification model; and
determining, based on an abnormality score output by the trained image classification model for the image of lines, whether there are abnormal patterns in behavior of one or more of the plurality of other entities.

11. The non-transitory computer-readable medium of claim 10, wherein the operations further comprise:
sorting, by the server system, variables included in the variable matrix in descending order from largest variable value to smallest variable value; and
transforming, by the server system prior to inputting the variable matrix into the trained image classification model, the variable matrix, such that columns of the variable matrix correspond to the variable dimension and rows of the variable matrix correspond to the entity dimension.

12. The non-transitory computer-readable medium of claim 10, wherein the operations further comprise:
normalizing, by the server system, variables included in the variable matrix such that the trained image classification model assigns equal weight to different entities corresponding to variables having different values.

13. The non-transitory computer-readable medium of claim 10, wherein the operations further comprise:
performing, based on determining that the electronic communication requested by the given entity corresponds to anomalous behavior, one or more preventative actions with respect to the given entity requesting to initiate the electronic communication, wherein the one or more preventative actions include one or more actions of the following types of actions: denying the electronic communication, requesting an authentication factor from the given entity, blocking future actions of the given entity on the server system, and sending the electronic communication for further evaluation.

14. The non-transitory computer-readable medium of claim 10, wherein the operations further comprise:
calculating, based on retrieving variables form the variable database, a plurality of variables for the given entity, wherein the calculating includes determining one or more variables for two or more different intervals of time, and wherein the variables included in the variable matrix include one or more of the following types of variables: transaction count, transaction amount, transaction type count, transaction type amount; and
storing the plurality of variables in a variable database in association with an identifier of the given entity.

15. The non-transitory computer-readable medium of claim 10, wherein the variable matrix includes variables generated based on variables for a sender and a receiver for respective electronic transactions.

16. A system comprising:
a processor; and
a non-transitory computer-readable medium having stored thereon instructions that are executable by the processor to cause the system to perform operations comprising:
receiving, from an entity via a computing device, a request to authorize an action;
determining, using a trained machine learning model, whether to authorize the action, wherein the trained machine learning model is trained by:
retrieving different sets of variables for respective ones of a plurality of entities for prior requested actions;
generating, based on the different sets of variables, a plurality of variable matrices for respective ones of the plurality of entities, wherein a given variable matrix includes a variable dimension that corresponds to a number of variables determined for a given entity and an entity dimension that corresponds to a number of other entities associated with the prior requested actions requested by the given entity;
generating, based on the plurality of variable matrices, images of lines, wherein the lines correspond to columns of respective variable matrices which correspond to the variables determined for the plurality of entities;
assigning labels to the images of lines based on known anomaly identifiers for the plurality of entities corresponding to the images of lines, wherein the known anomaly identifiers are included in the retrieved different sets of variables;
inputting the images of lines and corresponding assigned labels into the machine learning model; and
in response to determining that the entity requesting the action is exhibiting anomalous behavior based on output of the trained machine learning model, performing one or more preventative actions with respect to the entity requesting the action.

17. The system of claim 16, wherein generating a given variable matrix for the given entity is performed by:
generating a graph of a set of variables for the given entity, wherein a first dimension of the graph indicates the other entities and a second dimension of the graph indicates values of the set of variables, wherein lines connecting points on the graph correspond to different ones of the set of variables, wherein columns of the given variable matrix correspond to lines of the graph, and wherein the lines of the graph represent different ones of the set of variables.

18. The system of claim 17, wherein the instructions are further executable by the processor to cause the system to:
compare the graph of the set of variables with the output of the trained machine learning model for the given variable matrix, wherein the determining is further performed based on the comparing, and wherein the comparing includes identifying whether the graph includes jumps for one or more variables between points in the graph corresponding to one or more other entities.

19. The system of claim 16, wherein the trained machine learning model is further trained by:
sorting variables included in the plurality of variable matrices in descending order, for a given variable included in the plurality of variable matrices, from largest to smallest; and
normalizing variables included in the plurality of variable matrices such that the trained machine learning model does not include a bias toward corresponding to variables having the largest variable values relative to other variables in the plurality of variable matrices.

20. The system of claim 16, wherein the request to authorize the action is a request to authorize communication between two or more servers in a network of servers, wherein the given entity is a server included in the network of servers, and wherein the other entities are one or more other servers included in the network of servers.
